(19) United States
(12) Patent Application Publication
(10) Pub. No.: US 2021/0383367 A1
(43) Pub. Date: Dec. 9, 2021

(54) WALLET SERVER, WALLET SYSTEM, AND PROGRAM

(71) Applicant: TOYOTA JIDOSHA KABUSHIKI KAISHA, Toyota-shi (JP)

(72) Inventors: Yurika TANAKA, Yokosuka-shi (JP); Hideo HASEGAWA, Nagoya-shi (JP); Nozomu YOSHIOKA, Kasugai-shi (JP); Tsuyoshi TAKESHITA, Nagoya-shi (JP); Shoichiro SUZUKI, Tokyo (JP); Kohei ICHIHARA, Machida-shi (JP); Shota YAMAMOTO, Tokyo (JP); Junya CHIKANISHI, Tokyo (JP)

(73) Assignee: TOYOTA JIDOSHA KABUSHIKI KAISHA, Toyota-shi (JP)

(21) Appl. No.: 17/228,926

(22) Filed: Apr. 13, 2021

(30) Foreign Application Priority Data
Jun. 9, 2020 (JP) 2020-100083

(51) Int. Cl. G06Q 20/36; G06Q 20/10

(52) U.S. Cl. CPC G06Q 20/3674; G06Q 20/102

(57) ABSTRACT

A processor provided with hardware is provided. The processor acquires user information of a plurality of the user terminals output from a store terminal that is provided in a store and executes payment settlement processing, generates, when a predetermined user terminal among the user terminals executes the payment settlement processing, group consumption information based on group information containing the user information of the predetermined user terminal and the user information of the other user terminals and consumption information associated with each of the user terminals contained in the group information, and generates payment information containing an allotted amount of the predetermined user terminal with respect to a target user terminal based on the group consumption information. The payment information contains information on a user ID of the predetermined user terminal, user IDs of the other user terminals, and the allotted amount.

### CROSS-REFERENCE TO RELATED APPLICATION

This application claims priority to Japanese Patent Application No. 2020-100083 filed on Jun. 9, 2020, incorporated herein by reference in its entirety.

### BACKGROUND

### 1. Technical Field

The present disclosure relates to a wallet server, a wallet system, and a program.

### 2. Description of Related Art

Japanese Unexamined Patent Application Publication No. 2014-178756 (JP 2014-178756 A) discloses a technique that conditions when a card member (treating member) treats another card member (treated member) are determined in advance and a notification indicating an offer that the treating member pays for the treated member is transmitted from a user terminal of the treating member to a user terminal of the treated member.

### SUMMARY

In a group consisting of a plurality of users, there may be a case where one user of the group pays all of fees of products and services provided to the group using a user terminal to collectively make a payment of the fees of other users in the group temporarily or treat other users. In this case, the user needs to rely on the user's own memory, etc. as to which user pays the fee of which user temporarily or treats which user. Therefore, there has been a demand for a technique that can clearly specify the amount that one user has paid temporarily or treated or the amount paid by another user temporarily or treated by another user so as to identify a payment status when one user collectively pays the fees for users in the group.

The present disclosure has been made in view of the above, and an object thereof is to provide a wallet server, a wallet system, and a program that clearly identifies the amount paid by one user collectively and the amount of money paid by another user collectively, and identifies the payment status when one of the users pays the fees collectively.

A wallet server according to the present disclosure includes a processor provided with hardware. The processor acquires user information of a plurality of user terminals output from a store terminal that is provided in a store and executes payment settlement processing, generates, when a predetermined user terminal among the user terminals executes the payment settlement processing, group consumption information based on group information containing the user information of the predetermined user terminal and the user information of the other user terminals and consumption information associated with each of the user terminals contained in the group information, and generates payment information including an allotted amount of the predetermined user terminal with respect to a target user terminal based on the group consumption information.

A wallet system according to the present disclosure includes: a first device including a first processor that is provided with hardware installed in a store and executes payment settlement processing using a user terminal held by a user and outputs payment settlement information relating to payment settlement; and a second device including a second processor that is provided with hardware, acquires user information of a plurality of the user terminals output from the first device, generates, when a predetermined user terminal among the user terminals executes the payment settlement processing, group consumption information based on group information containing the user information of the predetermined user terminal and the user information of the other user terminals and consumption information associated with each of the user terminals contained in the group information, and generates payment information containing an allotted amount of the predetermined user terminal with respect to a target user terminal based on the group consumption information.

A program according to the present disclosure causes a processor provided with hardware to execute: acquisition of user information of a plurality of user terminals output from a store terminal that is provided in a store and executes payment settlement processing; generation of, when a predetermined user terminal among the user terminals executes the payment settlement processing, group consumption information based on group information containing the user information of the predetermined user terminal and the user information of the other user terminals and consumption information associated with each of the user terminals contained in the group information; and generation of payment information including an allotted amount of the predetermined user terminal with respect to a target user terminal based on the group consumption information.

According to the present disclosure, the user can clearly specify the amount paid by the user collectively for the users of the group or the amount paid by another user and identify the payment status when payment is made collectively as a group.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically showing a configuration of a wallet system according to an embodiment;

FIG. 2 is a block diagram schematically showing a configuration of a wallet server according to the embodiment;

FIG. 3 is a block diagram schematically showing a configuration of a payment service provider server according to the embodiment;

FIG. 4 is a block diagram schematically showing a configuration of a user terminal according to the embodiment;

FIG. 5 is a block diagram schematically showing a configuration of a store terminal according to the embodiment;

FIG. 6 is a flowchart showing an example of a processing method by the wallet system according to the embodiment;

FIG. 7 is a flowchart showing an example of a generation method of group consumption information and treat information by the wallet server according to the embodiment;

FIG. 8 is a diagram showing an example of group information and consumption information generated by the wallet server according to the embodiment;

FIG. 9 is a diagram showing an example of the treat information generated by the wallet server according to the embodiment;

FIG. 10 is a diagram showing an example of a gift presenting method via the wallet server of the embodiment; and

FIG. 11 is a diagram showing an example of the treat information of a user who has received a product as a gift, which is generated by the wallet server of the embodiment.

### DETAILED DESCRIPTION OF EMBODIMENTS

Hereinafter, embodiments of the present disclosure will be described below with reference to the drawings. In all the drawings of the following embodiments, the same or corresponding portions are designated by the same reference numerals. Further, the present disclosure is not limited to the embodiments described below. The components in the following embodiments also include those that can be easily replaced by those skilled in the art, or those that are substantially identical.

Wallet System

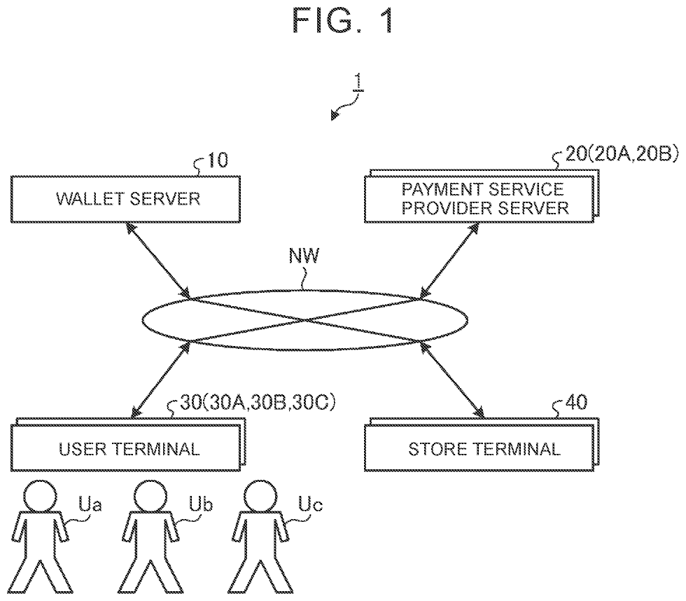

A configuration of a wallet system according to an embodiment will be described. As shown in FIG. 1, a wallet system 1 includes a wallet server 10, a payment service provider server 20, a user terminal 30, and a store terminal 40.

The wallet server 10, the payment service provider server 20, the user terminal 30, and the store terminal 40 are configured to be communicable with each other via a network NW. The network NW is composed of, for example, the Internet network and a mobile phone network. The network NW may include, for example, other communication networks such as a wide area network (WAN), a telephone communication network such as a mobile phone, and a wireless communication network such as Wi-Fi (registered trademark).

Wallet Server

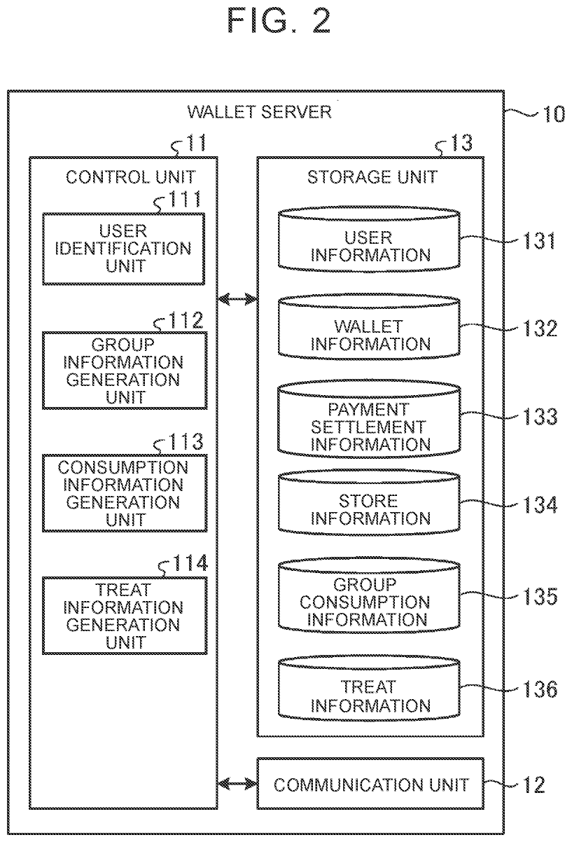

The wallet server 10 as a second device including a wallet server is a server for comprehensively managing the wallet system according to the present embodiment, and is managed by a wallet system administrator. As shown in FIG. 2, the wallet server 10 includes a control unit 11 as a second processor, a communication unit 12, and a storage unit 13.

Specifically, the control unit 11 is composed of a processor that is provided with hardware, such as a central processing unit (CPU), a digital signal processor (DSP), and a field-programmable gate array (FPGA), and a main storage unit, such as a random access memory (RAM) and a read-only memory (ROM). The storage unit 13 includes, for example, a recording medium selected from an erasable programmable ROM (EPROM), a hard disk drive (HDD), and a removable medium, etc. Examples of the removable media include disc recording media such as a universal serial bus (USB) memory, a compact disc (CD), a digital versatile disc (DVD), and a Blu-ray (registered trademark) disc (BD). The storage unit 13 can store an operating system (OS), various programs, various tables, and various databases, etc.

The control unit 11 loads a program stored in the storage unit 13 into a work area of the main storage unit and executes the loaded program, and controls each component unit, etc. through execution of the program. The program may be a learned model generated through machine learning, for example. The learned model can be generated through machine learning such as deep learning using a neural network, for example, with an input-output data set of a predetermined input parameter and an output parameter as teaching data. With the configuration above, the control unit 11 can realize functions of a user identification unit 111, a group information generation unit 112, a consumption information generation unit 113, and a treat information generation unit 114. The details of the functions of the user identification unit 111, the group information generation unit 112, the consumption information generation unit 113 and the treat information generation unit 114 will be described later.

The communication unit 12 as an information acquisition unit is composed of, for example, a local area network (LAN) interface board or a wireless communication circuit for wireless communication. The LAN interface board and the wireless communication circuit are connected to the network NW such as the Internet, which is a public communication network. The communication unit 12 connects to the network NW and communicates with the payment service provider server 20, the user terminal 30, and the store terminal 40.

The storage unit 13 includes, for example, a recording medium such as an erasable programmable ROM (EPROM), a hard disk drive (HDD), and a removable medium. Examples of removable media include disc recording media such as a universal serial bus (USB) memory, a compact disc (CD), a digital versatile disc (DVD), and a Blu-ray (registered trademark) disc (BD). The storage unit 13 can store an operating system (OS), various programs, various tables, and various databases, etc. The storage unit 13 according to the present embodiment stores user information 131, wallet information 132, and payment settlement information 133 for each user of the wallet system 1. Further, the storage unit 13 stores store information 134, group consumption information 135, and treat information 136.

The user information 131 is information about the user who uses the wallet system 1. Examples of the user information 131 include, for example, a user identification (ID), a password, a user name, user contact information (for example, an address, a telephone number, and an e-mail address), usage registration history, and information on payment means registered as deposit means, information on payment means registered as payment settlement means, and a password for making a payment settlement, of a user who has registered for use of the wallet system. The user ID and the password in the user information 131 are used for authentication processing such as logging in to the wallet server 10.

The wallet information 132 is information related to a wallet of the wallet system 1. The wallet is a virtual deposit and withdrawal account of electronic money. The wallet information 132 includes, for example, the user ID, a balance of the electronic money, a deposit history of the electronic money, and a usage history of the electronic money.

The payment settlement information 133 is information related to payment settlement of the wallet system. The payment settlement information 133 includes the user ID, a payment settlement method used for making a payment settlement (e.g. payment by the electronic money (non-contact payment), payment by scanning, or payment by code), date and time information containing a date and time when the payment settlement is made, and a payment settlement history.

The store information 134 is information relating to facilities and terminals of the stores that use the wallet system 1. The store information 134 contains, for example, location information, information on foods, menus and services available, information on business dates and times, and information on coupons and campaigns, of store facilities such as various restaurants and cafeterias that provide food and services.

The group consumption information 135 contains information of a group composed of a plurality of users who uses the store, and information on consumption for each user associated with the group. That is, the group consumption information 135 contains group information containing user information that can distinguish the users who are grouped together as a group. The group consumption information 135 includes consumption information of products and amounts consumed by each user.

The treat information 136 as payment information contains information on, for each user, a user ID and the date and time when each user treats other users or is treated by other users. The treat information 136 contains information on user IDs (target user IDs) of other treated users and other treating users as users who involve treating, an amount paid by each user (treating amount) and an amount paid for each user (treated amount) as an allotted amount, a total treating amount for each target user ID, and a total treating amount for each user ID, etc., associated with the user IDs and the date. The treat information 136 may further include store information of the store used.

Payment Service Provider Server

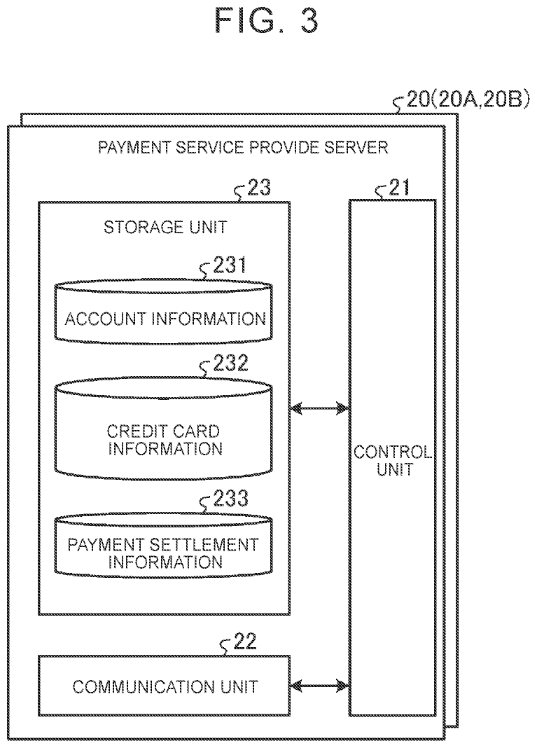

The payment service provider server 20 (20A, 20B) is a server for managing an account and a credit card of the user. The payment service provider server 20 is installed in a financial institution such as a bank, a Shinkin bank, a credit union, or a labor bank, or a credit card company. As shown in FIG. 3, the payment service provider server 20 includes a control unit 21, a communication unit 22, and a storage unit 23. The control unit 21, the communication unit 22, and the storage unit 23 are functionally the same as the control unit 11, the communication unit 12, and the storage unit 13, respectively. Further, in FIGS. 1 and 3, two payment service provider servers 20A, 20B are provided. However, the present disclosure is not necessarily limited to the two payment service provider servers.

The storage unit 23 stores account information 231, credit card information 232, and payment settlement information 233 for each user of the wallet system 1. The account information 231 contains, for example, the name of the user, an account number, an account balance, and a deposit and withdrawal history. The credit card information 232 contains, for example, the name of the user, a credit card number, an expiration date of the credit card, a usage limit amount, and a card usage history. Examples of the payment settlement information 233 include the user ID, the payment settlement means, and the payment settlement history. The storage unit 23 may further store reward point information on return of reward points by the payment service provider, etc., and campaign information that is information on various campaigns held by a payment settlement service provider. Examples of the reward point information include, for example, the name of the user, a unique user ID, the number of reward points associated with the account information or the credit card information. Examples of the campaign information include information on the reward point rate when a predetermined payment settlement method is used, information on an area where the campaign is carried out, and information on coupons provided to the user.

User Terminal

The user terminal 30 (30A, 30B, 30C) is a computer terminal operated by the user. Examples of the user terminal 30 include smartphones, mobile phones, tablet terminals, wearable computers, and personal computers held by the user, and car navigation systems mounted on vehicles. The user terminal 30 may be any terminal as long as the user terminal 30 can transmit and receive information to and from the wallet server 10.

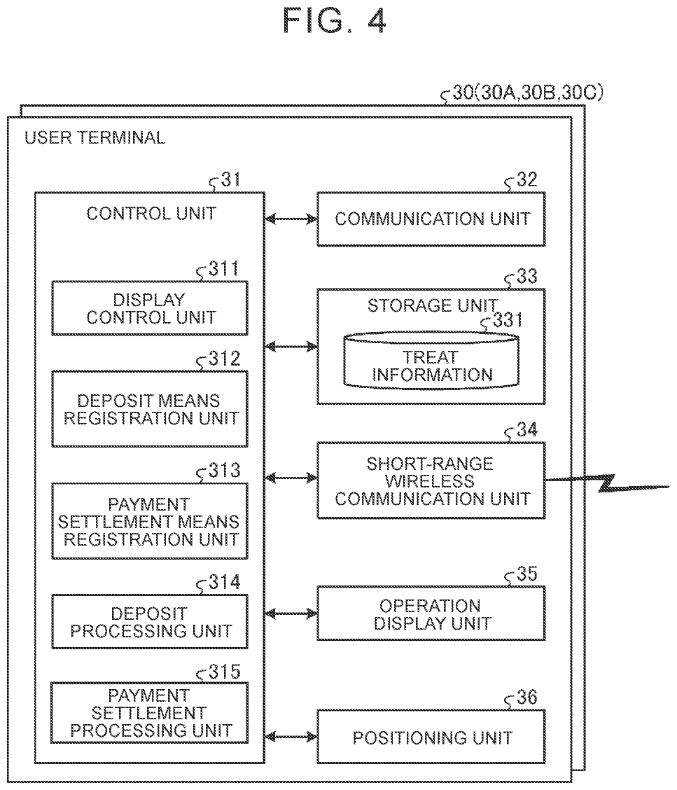

As shown in FIG. 4, the user terminal 30 as a third device includes a control unit 31, a communication unit 32, a storage unit 33, a short-range wireless communication unit 34, an operation display unit 35, and a positioning unit 36. The control unit 31, the communication unit 32, and the storage unit 33 are functionally the same as the control unit 11, the communication unit 12, and the storage unit 13 in the wallet server 10 shown in FIG. 2, respectively. As shown in FIG. 4, the control unit 31 as a third processor functions as a display control unit 311, a deposit means registration unit 312, a payment settlement means registration unit 313, a deposit processing unit 314, and a payment settlement processing unit 315. Further, in FIGS. 1 and 4, the three user terminals 30A, 30B, and 30C are provided. However, the present disclosure is not necessarily limited to three user terminals.

The display control unit 311 controls contents to be displayed on an operation display unit 35 including a display. The display control unit 311 displays, for example, a member registration screen when the user registers as a member, a log-in screen when the user logs in to the wallet system 1, and a deposit screen when the user deposits money to the electronic money of the wallet, and a payment settlement screen when the user makes a payment settlement, on the operation display unit 35 to be operated based on user operations such as a touch operation and a flick operation by the user. The display control unit 311 transitions each screen based on the operations by the user.

The deposit means registration unit 312 registers the deposit means for depositing money to the electronic money. The deposit means registration unit 312 transmits, to the wallet server 10, a deposit means registration request for registering a plurality of different payment settlement methods operated by a plurality of service providers as means of depositing money to the electronic money. Specifically, the different payment settlement methods operated by the service providers includes, for example, the bank account and the credit card. The control unit 11 of the wallet server 10 that receives the deposit means registration request from the deposit means registration unit 312 stores the payment settlement method contained in the deposit means registration request in the storage unit 13 as the user information 131 and registers the payment settlement method as the deposit means.

The payment settlement means registration unit 313 registers various payment settlement means. The payment settlement means registration unit 313 transmits a payment settlement means registration request for registering the payment settlement means to the wallet server 10. The control unit 11 of the wallet server 10 that receives the payment settlement means registration request from the payment settlement means registration unit 313 stores the payment settlement method contained in the payment settlement means registration request in the storage unit 13 as the user information 131 to register the payment settlement method as the payment settlement means. In addition, a payment settlement method may be registered instead of the payment settlement means.

The deposit processing unit 314 deposits money to the electronic money in the wallet. Specifically, the deposit processing unit 314 transmits, to the wallet server 10, a deposit request for depositing money to the electronic money using the payment settlement means registered as the deposit means. The control unit 11 of the wallet server 10 that receives the deposit request from the deposit processing unit 314 increments a balance of the electronic money in the wallet based on deposit amount information contained in the deposit request. That is, the control unit 11 updates the wallet information 132 stored in the storage unit 13 in accordance with an increment in the balance of the electronic money in the wallet.

The payment settlement processing unit 315 executes payment settlement using the payment settlement method selected by the user. Specifically, the payment settlement processing unit 315 transmits a payment settlement request to the store terminal 40 via the short-range wireless communication unit 34 as the payment settlement means. The payment settlement processing unit 315 may transmit the payment settlement request to the store terminal 40 by reading a one-dimensional code (also referred to as a one-dimensional symbol) such as a barcode or a two-dimensional code (also referred to as a two-dimensional symbol) such as a QR code (registered trademark) (hereinafter collectively referred to as a bar code symbol based on the International Standardization Organization (ISO) Standard and the International Electrotechnical Commission (IEC) Standard) displayed on the store terminal 40 using a camera, etc., of the user terminal 30. The payment settlement processing unit 315 may transmit the payment settlement request to the store terminal 40 by causing a code reader, etc., of the store terminal 40 to read a code displayed on the user terminal 30 as the payment settlement means. The payment settlement request transmitted from the payment settlement processing unit 315 to the store terminal 40 may or may not contain information indicating a payment settlement amount (hereinafter referred to as “payment settlement amount information”).

When the user makes payment settlement with the bank account or by the credit card, the payment settlement processing unit 315 transmits the payment settlement request to the wallet server 10 to make a payment settlement using any of the payment settlement means. The control unit 11 of the wallet server 10 that receives the payment settlement request from the payment settlement processing unit 315 transmits the payment settlement amount information contained in the payment settlement request to the payment service provider server 20.

Further, when the user makes a payment settlement using the electronic money, a control unit 41 of the store terminal 40, which will be described later, transmits the payment settlement request containing the payment settlement amount information to the wallet server 10 via the network NW. The control unit 11 of the wallet server 10 that receives the payment settlement request from the store terminal 40 deducts the payment settlement amount from the balance of the electronic money in the wallet based on the payment settlement amount contained in the payment settlement request. That is, the control unit 11 updates the wallet information 132 and the payment settlement information 133 stored in the storage unit 13 in accordance with the deduction in the balance of the electronic money in the wallet.

The storage unit 33 stores various screen data to be displayed on the operation display unit 35 by the display control unit 311. Further, the storage unit 33 temporarily stores the user information 131, the wallet information 132, the payment settlement information 133, and reward point information, for example, as needed. The storage unit 33 contains treat information 331 containing various pieces of information when the user treats other users using the user terminal 30 or the user is treated by another user.

The short-range wireless communication unit 34 has a communication function conforming to standards such as near field radio communication (NFC), Bluetooth (registered trademark) low energy (BLE), and infrared data association (IrDA). For example, when the user makes a payment settlement using the electronic money, the user terminal 30 performs short-range wireless communication with the store terminal 40 via the short-range wireless communication unit 34.

The operation display unit 35 is composed of, for example, a touch panel display, and has an input function for receiving an operation using a finger of the user or a pen, and a display function for displaying various pieces of information under the control of the display control unit 311.

The positioning unit 36 receives radio waves from a global positioning system (GPS) satellite and detects the location information of the user terminal 30. The control unit 31 transmits the location information of the user terminal 30 to the wallet server 10, the payment service provider server 20, or the store terminal 40 via the network NW.

Store Terminal

The store terminal 40 as a first device is provided in, for example, a store 2 that is a member store where the wallet system 1 can be used. The store terminal 40 may be a server that also functions as a virtual store opened on the Internet, a so-called electronic commerce (EC) site.

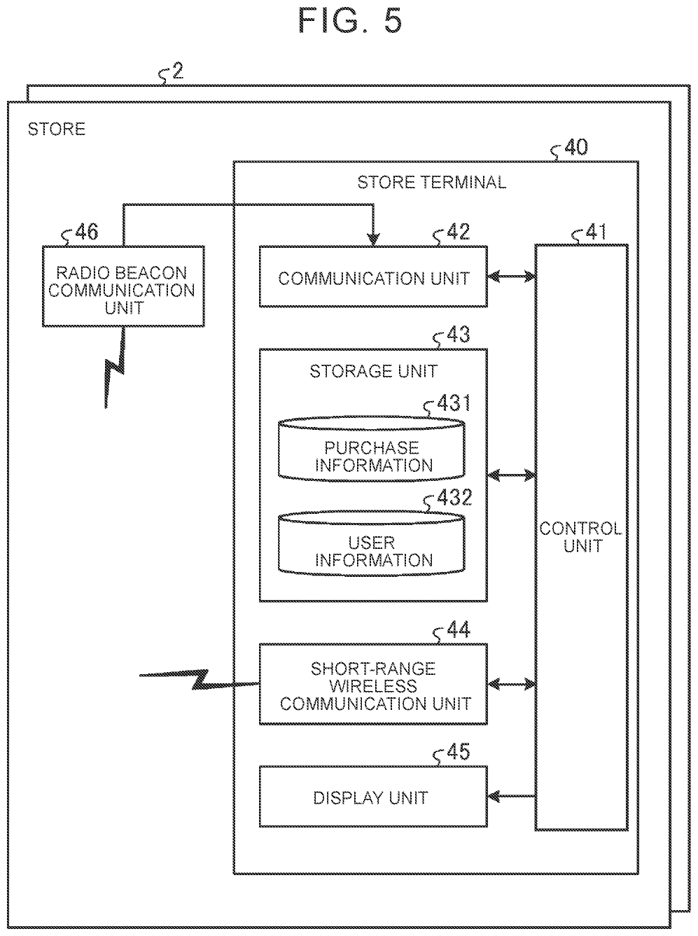

As shown in FIG. 5, the store terminal 40 includes the control unit 41, a communication unit 42, a storage unit 43, a short-range wireless communication unit 44, and a display unit 45. The control unit 41 as a first processor, the communication unit 42, the storage unit 43, and the short-range wireless communication unit 44 are functionally the same as the control unit 11, the communication unit 12, the storage unit 13, and the short-range wireless communication unit 34, respectively. The display unit 45 is composed of, for example, a liquid crystal display (LCD) and an organic electroluminescence display (OLED), and displays information under the control of the control unit 41.

The store 2 provided with the store terminal 40 may be provided with a radio beacon communication unit 46. The radio beacon communication unit 46 has, for example, an infrared beacon (IR beacon) realized by a radio beacon technology using infrared rays, or a communication function conforming to the BLE having a proximity notification function capable of identifying the user terminal 30 by receiving a signal from the target user terminal 30.

Treat Information Generation Method by Wallet Server

Next, a treat information generation method by the wallet system 1 including the wallet server 10 according to the present embodiment will be described. In the following description, information is transmitted and received via the network NW. The description of transmission and reception via the network NW will be omitted. Further, when information is transmitted and received among the wallet server 10, each payment service provider server 20 (20A, 20B), each user terminal 30 (30A, 30B, 30C), and each store terminal 40, the information is transmitted and received in association with the identification information to independently identify the payment service provider server 20, the user terminal 30, and the store terminal 40. However, the description thereof will also be omitted.

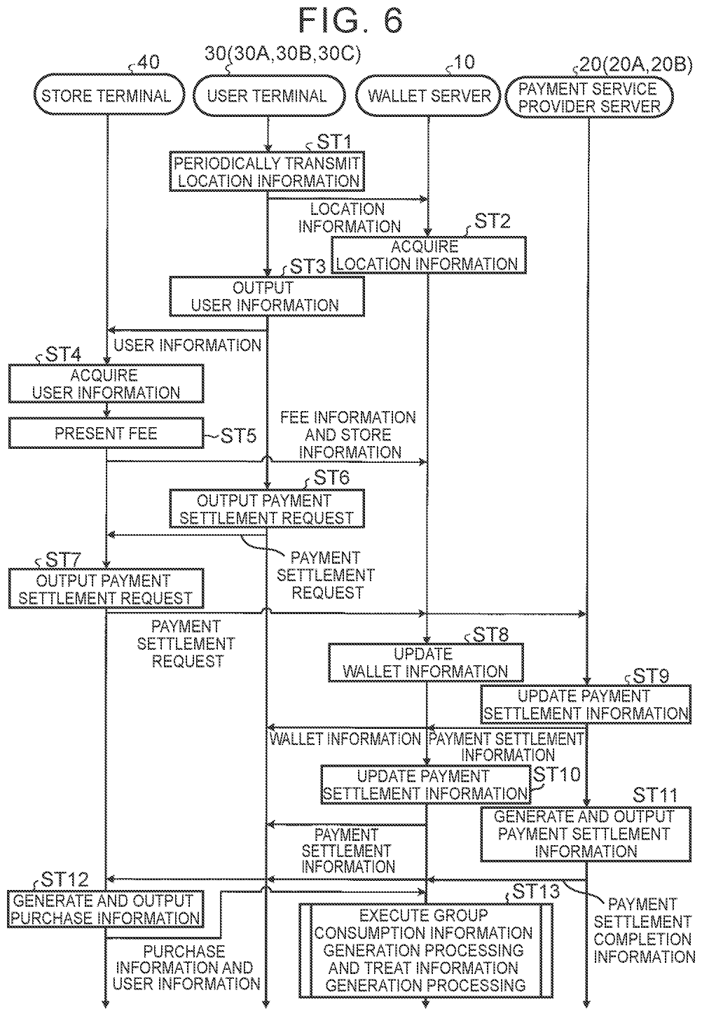

As shown in FIG. 6, first, in step ST1, the user terminals 30A to 30C each periodically or timely transmit the location information to the wallet server 10. In step ST2, the control unit 11 of the wallet server 10 stores the received location information of the user terminals 30A to 30C in the storage unit 13 as the user information 131. In the following description, it is assumed that the user terminals 30A, 30B, 30C are user terminals held by the users Ua, Ub, Uc, respectively, and the users Ub, Uc use the store 2 in a group together with the user Ua who holds the user terminal 30A. The number of users in the group composed of users who each have the user terminal 30 is not necessarily limited to three, and may be two or four or more.

In steps ST3 and ST4, the store terminal 40 acquires the user information 432 that can identify the respective user terminals 30A to 30C from the user terminals 30A to 30C held by the users Ua to Uc who visit the store, respectively. The storage unit 43 stores the user information 432 acquired by the store terminal 40. As a method of acquiring the user information 432, the following various methods can be adopted.

For example, in step ST3, the user terminals 30A to 30C held by the users Ua to Uc communicate with the radio beacon communication unit 46 provided in the store 2. With the processing above, in step ST4, the user information is output from the radio beacon communication unit 46 to the store terminal 40, and the store terminal 40 can acquire the user information 432 containing the user ID as user-specific information related to the user terminals 30A to 30C. When the users Ua to Uc are members in a group, the communication between the user terminals 30A to 30C and the radio beacon communication unit 46 is continuously performed. Therefore, a communication time stamp, for example, is close to each other. Therefore, the control unit 41 of the store terminal 40 can associate the user information 432 acquired from each of the user terminals 30A to 30C with each other based on the communication time stamp, etc.

For example, in step ST4, the store terminal 40 can acquire the user information 432 by causing a code reader, for example, of the store terminal 40 to read the barcode symbols displayed on the user terminals 30A to 30C, such as the barcode symbol for coupons, in step ST3. When the users Ua, Ub, Uc are members of the group, the user terminals 30A to 30C are made to display the barcode symbols associated with each other and the common barcode symbol. Association of the barcode symbols with each other can be realized as the short-range wireless communication units 34 of the user terminals 30A to 30C communicate with each other. With the processing above, the user information 432 acquired from the user terminals 30A to 30C can be associated with each other.

For example, in step ST3, the display unit 45 of the store terminal 40 is caused to display a different barcode symbol each time the display is switched. The same barcode symbol is read by the cameras of the user terminals 30A to 30C included in the group, whereby the user information 432 can be acquired in step ST4. When the users Ua to Uc are members in the group, the barcode symbols read by the user terminals 30A to 30C are the same one-time barcode symbol. Therefore, the user information 432 acquired from the user terminals 30A to 30C can be associated with each other.

Meanwhile, the users Ua to Uc who have entered the store 2 provided with the store terminal 40 eat, receive a predetermined service from a clerk, and hand over the product to the clerk. In step ST5, the clerk urges the users U of the user terminals 30 to pay a fee using the store terminal 40. The user Ua makes a payment for total of fees of the users Ua to Uc on behalf of the users Ua to Uc. The control unit 41 causes the display unit 45 of the store terminal 40 to display the amount of fee. The store terminal 40 transmits fee information and the store information to the wallet server 10.

After the step above, in step ST6, the payment settlement processing unit 315 of the user terminal 30 issues, to the store terminal 40, the payment settlement request for settling the payment settlement amount determined in step ST5 using the electronic money deposited in the wallet or by displaying a predetermined code, for example. During the processing above, the payment settlement processing unit 315 of the user terminal 30 may output the user information to the store terminal 40.

Subsequently, in step ST7, the control unit 41 outputs the payment settlement request acquired from the user terminal 30 to the wallet server 10 and the payment service provider server 20. During the processing above, the control unit 41 may output the user information acquired from the user terminal 30 to the wallet server 10 and the payment service provider server 20. Note that, the payment settlement request may be transmitted to either of the wallet server 10 and the payment service provider server 20. Further, the user information may be transmitted from the store terminal 40 to the wallet server 10 in response to a transmission request from the wallet server 10.

In step ST8, the control unit 11 of the wallet server 10 updates the wallet information 132 stored in the storage unit 13 in accordance with the payment settlement amount. When the control unit 11 receives the user information, the control unit 11 may update the user information 131. The control unit 11 transmits the updated wallet information 132 to the user terminal 30.

In step ST9, the control unit 21 of the payment service provider server 20 updates the payment settlement information 233 stored in the storage unit 23 in accordance with the payment settlement amount. The payment service provider server 20 transmits the updated payment settlement information 233 to the wallet server 10.

In step ST10, the control unit 11 of the wallet server 10 updates the payment settlement information 133 stored in the storage unit 23 with the received payment settlement information 233. The control unit 11 transmits the updated payment settlement information 133 to the user terminal 30.

Subsequently, in step ST11, the control unit 21 of the payment service provider server 20 transmits payment settlement completion information containing the content indicating that the payment settlement processing is completed to the wallet server 10, the user terminal 30, and the store terminal 40. Note that, the control unit 11 of the wallet server 10 may execute all of steps ST8 to ST11. Further, the control unit 21 of the payment service provider server 20 may execute all of steps ST8 to ST11.

In step ST12, the control unit 41 of the store terminal 40 generates the purchase information 431. That is, after receiving the payment completion information, the control unit 41 generates the purchase information 431 containing information on products and services for which payments are settled by the user Ua using the user terminal 30A and the payment settlement amount, etc. For example, when the users Ua to Uc eat at the store 2 and the user Ua makes a payment settlement on behalf of the users Ua to Uc, the control unit 41 generates the purchase information 431 containing information on the contents of menus for meals of the users Ua to Uc, and information on the prices of menus of the respective users, etc. The control unit 41 associates the generated purchase information 431 with the user information 432 acquired in step ST4 and transmits the information to the wallet server 10. The control unit 11 of the wallet server 10 stores the received purchase information 431 contained in the store information 134 in the storage unit 13, and stores the received user information 432 in the storage unit 13 as the user information 131.

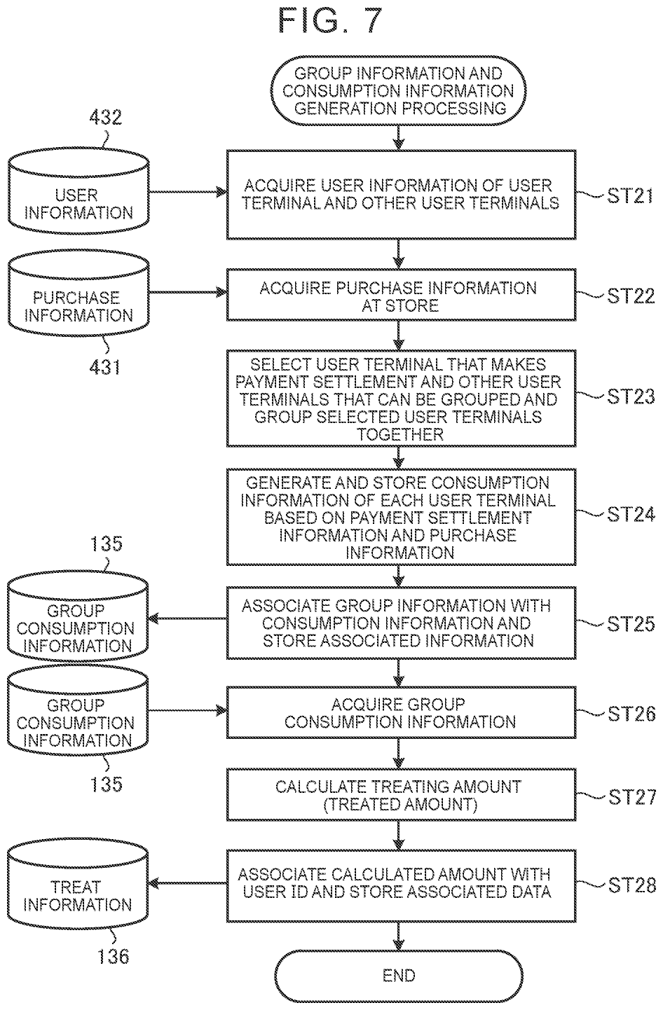

In step ST13, the control unit 11 of the wallet server 10 generates the group consumption information 135 and the treat information 136. Specifically, as shown in FIG. 7, first, in step ST21, the user identification unit 111 of the control unit 11 acquires, with the plurality of user terminals 30, the user information 131 in the user terminals 30A to 30C held by the users Ua to Uc from the storage unit 13. With the processing above, the user identification unit 111 can acquire the user information 432 received from the store terminal 40. Further, in step ST22, the user identification unit 111 reads out and acquires, from the storage unit 13, the purchase information 431 received from the store terminal 40.

Next, in step ST23, the group information generation unit 112 of the control unit 11 selects the user information 131 of the user terminal 30A of the user Ua who has made the payment settlement at the store 2 from the acquired user information 432 based on the purchase information 431. Next, the group information generation unit 112 retrieves, from the user information 131, other user terminals that can be grouped with the user terminal 30A of the user Ua, that is, the user terminals 30B, 30C of the users Ub, Uc, based on the information contained in the acquired user information 432. The information contained in the user information 432 includes, for example, the location information on the users Ua to Uc at the time when the users Ua to Uc use the store 2, information on reading of the barcode symbol using the user terminals 30A to 30C at the store 2, and information on reading of the barcode symbol that are displayed on the user terminals 30A to 30C and read by the store terminal 40. With the processing above, the group information generation unit 112 identifies each of the users Ua to Uc who have used the store 2 as a group, and generates the group information in the group consumption information 135.

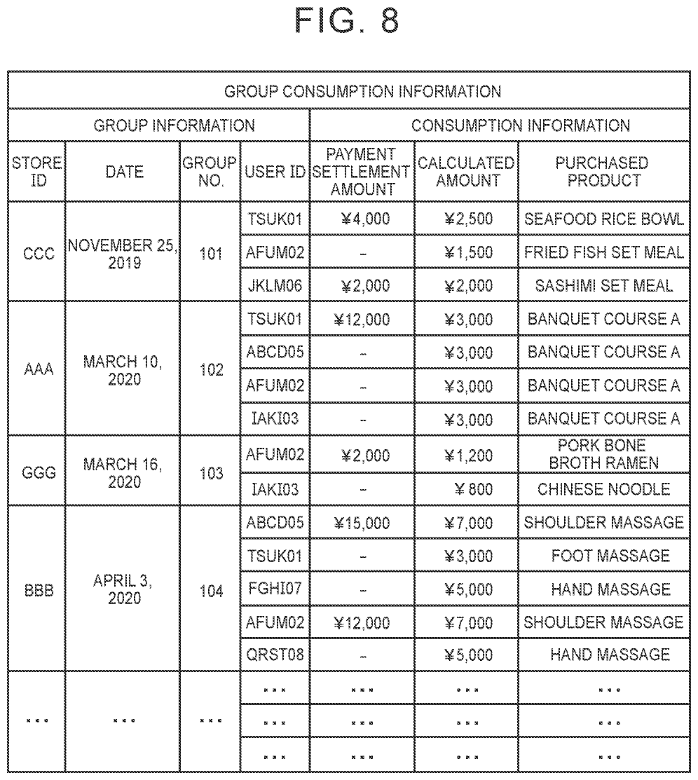

As shown in FIG. 8, the group information contains a store ID of the store 2 where the payment settlement has been made and the date when the group uses the store 2. The group information contains a user ID to which a group number that is the number for distinguishing the group is assigned and that is contained in the user information 131 of each of the users Ua to Uc. Other symbols, etc, may be used as the group number as long as the groups can be distinguished from each other in the group information.

Next, in step ST24 shown in FIG. 7, the consumption information generation unit 113 of the wallet server 10 generates consumption information of each of the users Ua to Uc in the group consumption information 135 based on the payment settlement information 133 and the purchase information 431 contained in the acquired store information 134. After that, in step ST25, the consumption information generation unit 113 of the control unit 11 associates the group information with the consumption information generated as described above based on the payment settlement information 133 and the user information 131 associated with the purchase information 431, and generates the group consumption information 135. The consumption information generation unit 113 then stores the generated group consumption information 135 in the storage unit 13.

Here, a specific example of the group consumption information 135 containing the consumption information associated with the group information will be described with reference to FIG. 8. As shown in FIG. 8, specifically, with a group having the group number (group No.) “101” as an example, the user Ua (user ID: “TSUK01”) makes a payment settlement for 4,000 yen at the store 2 having the store ID “CCC” on Nov. 25, 2019. Further, the user Uc (e.g. user ID: “JKLM06”) makes a payment settlement for 2,000 yen independently. The consumption information generation unit 113 calculates the amount to be paid by another user Ub (user ID: “AFUM02”) as a calculated amount based on the payment settlement amounts of the payment settlement processing executed by the users Ua, Uc.

Next, in step ST26 shown in FIG. 7, the treat information generation unit 114 of the control unit 11 reads and acquires the group consumption information 135 from the storage unit 13. After that, in step ST27, the treat information generation unit 114 calculates the treating amount or the treated amount to be contained in the treat information 136, that is, the allotted amount, based on the group consumption information 135. Subsequently, in step ST28, the treat information generation unit 114 stores the treating amount and the treated amount calculated in step ST27 in the storage unit 13 as the treat information 136 in association with the user ID of the user terminal 30. With the processing above, the treat information generation processing executed by the treat information generation unit 114 is completed.

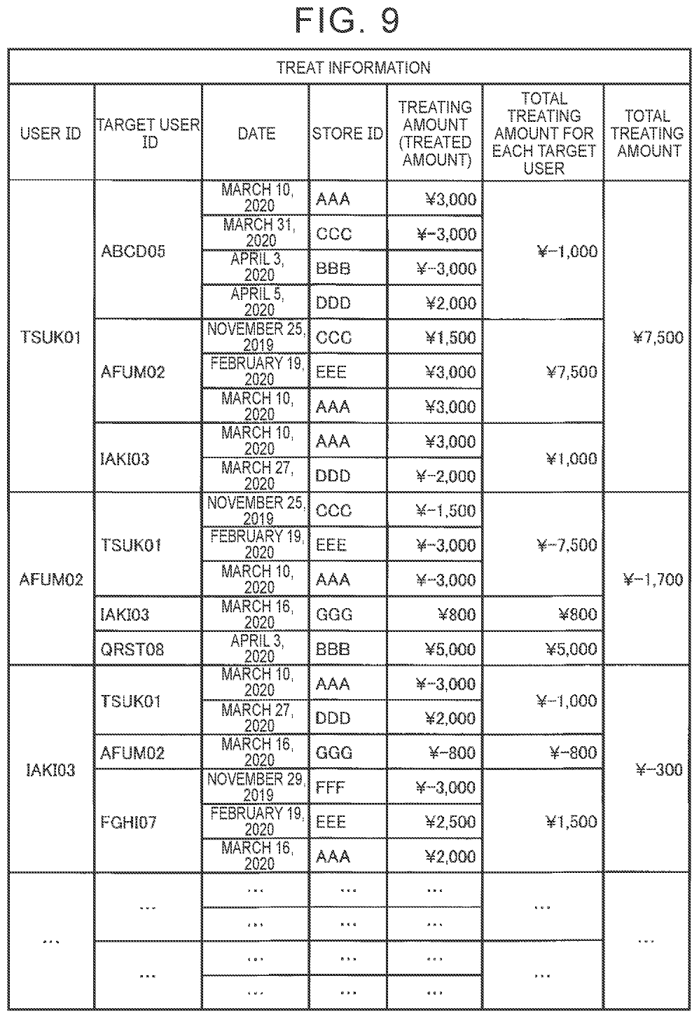

Here, specific examples of steps ST26 to ST28 will be described with reference to FIGS. 8 and 9. That is, in the example of the group consumption information shown in FIG. 8, the group having the group number “101” is exemplified. In the group, the user Ua (user ID: “TSUK01”) makes a payment settlement for 4,000 yen, and the calculated amount of the user Ub (user ID: “AFUM02”) is calculated as 1,500 yen. When the user Ua uses the user terminal 30A to input, to the user information, the setting indicating that the payment settlement made this time includes a treat for the user Ub, the calculated amount for the user Ub that is 1,500 yen is set as the treating amount of the user Ua for the user Ub. In other words, the calculated amount of the user Ub that is 1,500 yen is the treated amount of the user Ub by the user Ua. The treating amount and the treated amount above are contained in the treat information 136 and stored in the storage unit 13. Specifically, as shown in FIG. 9, the treating amount of the user Ua (user ID: “TSUK01”) for the user Ub (user ID: “AFUM02”) is stored as 1,500 yen.

Further, as shown in FIG. 8, specifically, with a group having the group number (group No.) “102” as an example, the user Ua (user ID: “TSUK01”) makes a payment settlement for 12,000 yen at the store 2 having the store ID “AAA” on Mar. 10, 2020. After that, the treat information generation unit 114 calculates the allotted amounts to be paid by four member users that constitute the group. In FIG. 8, the treat information generation unit 114 performs a calculation such that each user evenly pays 3,000 yen (obtained by dividing 12,000 by four). Note that, the calculated amount can be appropriately changed by the user who has made the payment settlement. As described above, when the products purchased at the store 2 contained in the purchase information 431 are products that are consumed by the entire group, such as “banquet course A”, the calculated amount may be calculated such that the amount for each user becomes substantially even or substantially equal. After that, when the user Ua (user ID: “TSUK01”) who has made the payment settlement inputs, to the user information, the setting indicating that the payment settlement this time includes a payment as a treat for other users using the user terminal 30A, the calculated amount for each of other three users (user IDs: “ABCD05”, “AFUM02”, and “IKAI03”) is the treating amount of the user Ua for each user. The treating amount of the user Ua and the treated amounts of the other three users are stored in the storage unit 13 as the treat information 136.

Further, with a group having the group number (group No.) “104”, one user (user ID: “ABCD05”) makes a payment settlement for 15,000 yen, and another user (user ID: “AFUM02”) makes a payment settlement for 12,000 yen. In this case, the consumption information is generated based on selection of users for treating by the two users who have made the payment settlement. In the example shown in FIG. 8, the user having the user ID “ABCD05” pays for the services received by two other users (user IDs: “TSUK01” and “FGHI07”) together. Similarly, the user having user ID “AFUM02” pays for the service received by one user (user ID: “QRST08”) together. In this case, the treat information generation unit 114 generates, as the treat information 136, information indicating that the user having user ID “ABCD05” pays 3,000 yen and 5,000 yen for the user having user ID “TSUK01” and “FGHI07”, respectively, based on the group consumption information above. Similarly, the treat information generation unit 114 generates, as the treat information 136, information indicating that the user having user ID “AFUM02” pays 5,000 yen for the user having user ID “QRST08”. As described above, each of the users constituting the group can set to whom the user treats and make a payment for the set user. The generated treat information 136 is stored in the storage unit 13.

Next, presenting processing executed when a predetermined user presents a product, etc. to another user who has treated the predetermined user to thank the treating user will be described. In the following description, a case where the user Ua holding the user terminal 30A presents a product, etc. to the user Ub holding the user terminal 30B will be described as an example.

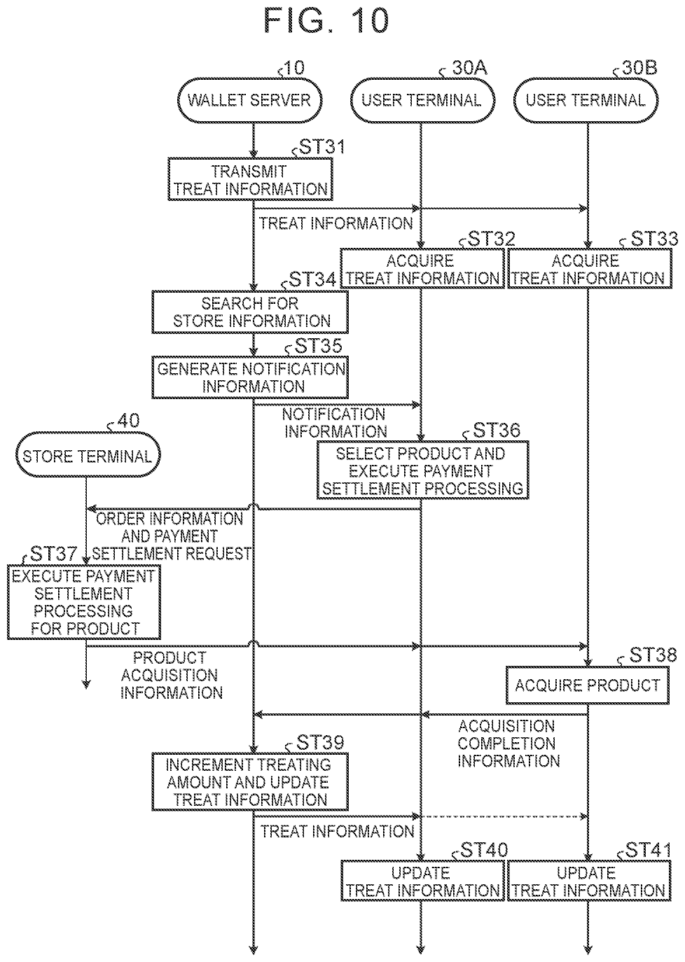

As shown in FIG. 10, in step ST31, the wallet server 10 transmits the treat information to the user terminal 30A of the predetermined user Ua. Here, the treat information 136 transmitted from the wallet server 10 to the user terminal 30A is the treat information 136 associated with the user Ua. Specifically, for example, the treat information 136 transmitted to the user terminal 30A of the user Ua (the user ID: “TSUK01” for example) is the treat information 136 of the user having user ID “TSUK01”. Similarly, the wallet server 10 also transmits the treat information associated with the user Ub (user ID: “ABSD05”) to the user terminal 30B of the user Ub.

In steps ST32 and ST33, the user terminals 30A, 30B update the treat information 331 stored in the storage unit 33 based on the acquired treat information 136. With the processing above, the treat information 331 in each of the user terminals 30A, 30B is synchronized with the treat information 136 of the wallet server 10.

Meanwhile, in step ST34, the control unit 11 of the wallet server 10 searches the storage unit 13 for the store information 134 to be notified to the user terminal 30A. Subsequently, in step ST35, the control unit 11 generates notification information that can prompt the user terminal 30A to purchase the product. The control unit 11 transmits the generated notification information to the user terminal 30A. In the user terminal 30A that has received the notification information, the user Ua uses the user terminal 30A to select a product contained in the notification information and execute the payment settlement processing. The user terminal 30A transmits order information containing information that can be transmitted to the user terminal 30B of the user Ub, or information that can be transmitted to a location where the user Ub can receive, and the payment settlement request to the store terminal 40. Note that, the payment settlement processing is the same as steps ST6 to ST11 shown in FIG. 6.

The store terminal 40 (the store ID: “XYZ” for example) that has received the order information and the payment settlement request executes the payment settlement processing for the product ordered in step ST37. The control unit 41 of the store terminal 40 generates product acquisition information associated with the selected product using the user terminal 30A and transmits the product acquisition information to the user terminals 30A, 30B. The product acquisition information is information for the user Ub holding the user terminal 30B to receive tangible products such as tangible objects and intangible products such as reward points and web money. The user terminal 30A may acquire the product acquisition information and transmit the product acquisition information to the user terminal 30B.

In step ST38, the user terminal 30B that has acquired the product acquisition information acquires the product using a predetermined method based on the product acquisition information. The user terminal 30B of the user Ub who has acquired the product transmits acquisition completion information to the wallet server 10. The acquisition completion information may be transmitted to the user terminal 30A.

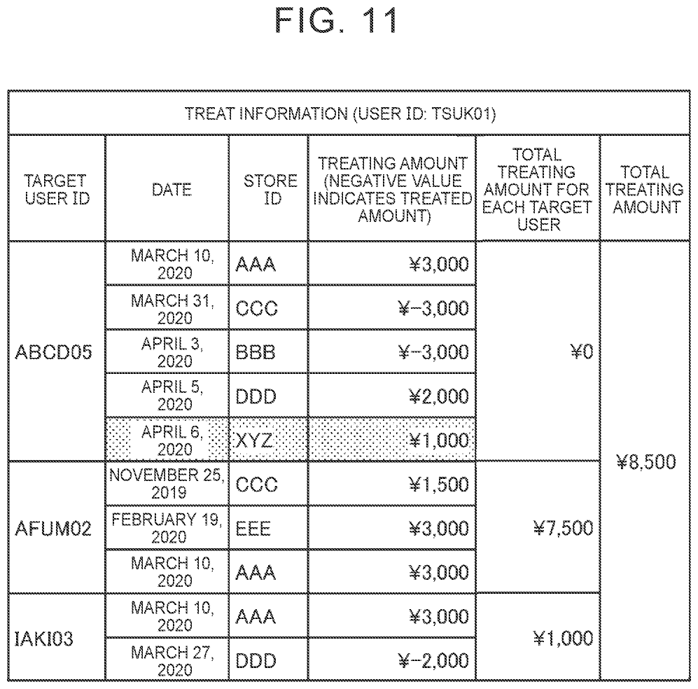

In step ST39, the wallet server 10 that has acquired the acquisition completion information adds an amount corresponding to the product presented by the user Ua (user ID: “TSUK01”) to the user Ub (user ID: “ABCD05”) to the treating amount of the user Ua (user ID: “TSUK01”) and updates the treat information 136 of the user Ua having user ID “TSUK01”. FIG. 11 shows an example of the updated treat information 136 of the user having user ID “TSUK01”. In the example shown in FIG. 11, the treating amount of the user having user ID “TSUK01” is incremented by 1,000 yen as the user having user ID “TSUK01” presents the product at 1,000 yen to the user having user ID “ABCD05” (the user Ub), and the treat information 136 is updated. The wallet server 10 transmits the treat information 136 associated with the user ID “TSUK01” among the updated treat information 136 to the user terminal 30A (step ST40). The wallet server 10 may also transmit the treat information 136 associated with the user ID “ABCD05” to the user terminal 30B. With the processing above, the presenting processing of presenting the product by the predetermined user to another user is completed.

Conventionally, there may be a case where a treated person misses an opportunity to thank a treating person. However, execution of the presenting processing by the wallet server 10 can offer the treated person an opportunity to thank the treating person. Therefore, the user can be further motivated for consumption.

When one of the users (user U) in a group composed of a plurality of users pays for the products and services provided to the group using the user terminal 30 to treat other users, the user can only rely on uncertain memory of the user to recall which user treats which user in the group. On the other hand, according to the embodiment of the present disclosure described above, even when a predetermined user treats another user in the group, the wallet server 10 can generate the treating amount and the treated amount of each user as the treat information 136. This makes it possible for the predetermined user to clearly specify the treating amount for other users and the treated amount by the other users and to identify the payment status.

Although the embodiment of the present disclosure has been specifically described above, the present disclosure is not limited to the embodiment, and various modifications based on the technical idea of the present disclosure are possible. The present disclosure also includes a configuration in which the components according to the present disclosure are appropriately combined. Further effects and modifications can be easily derived by those skilled in the art. Thus, broader aspects of the present disclosure are not limited to the embodiment, and modifications in various forms can be made. For example, the treat information table exemplified in the embodiment is merely an example, and a different treat information table may be used as necessary. The present disclosure is not limited by the description and the drawings that constitute a part of the present disclosure according to the present embodiment.

For example, presentation of a product from a predetermined user to another user is not limited to the product, and electronic money, etc. can be presented. Specifically, the wallet server 10 is configured such that the electronic money used in the payment service provider server 20A can be converted into the electronic money used in the payment service provider server 20B. With this configuration, when the electronic money is transmitted from the user terminal 30A to the user terminal 30B, such transmission of the electronic money is performed via the wallet server 10. With the processing above, the electronic money of the payment service provider server 20A used by the user terminal 30A is made exchangeable with the electronic money of the payment service provider server 20B used by the user terminal 30B to be equivalent to each other or with deducting a predetermined service fee. Therefore, instead of presenting the product from the user Ua of the user terminal 30A to the user Ub of the user terminal 30B, the user Ua can present the electronic money that can be used for payment settlement. This makes it possible for the treated user to present the electronic money corresponding to the treat to the treating user.

Recording Media

According to the embodiment, a program capable of executing a processing method by the wallet server 10, the payment service provider server 20, the user terminal 30, and the store terminal 40 can be recorded in a recording medium that is readable by a computer or other machines or devices (hereinafter referred to as the computer). The computer functions as the control units of the wallet server 10 and the user terminal 30 as the computer is caused to read the program stored in the recording medium and execute the program. Here, the recording medium that is readable by the computer means a non-transitory storage medium that accumulates information such as data and programs through an electrical, magnetic, optical, mechanical, or chemical action and from which the computer can read the information. Examples of the recording media removable from the computer among the recording media above include, for example, a flexible disk, a magneto-optical disk, a compact disc read-only memory (CD-ROM), a compact disc rewritable (CD-R/W), a digital versatile disc (DVD), a Blu-ray disc (BD), a digital audio tape (DAT), a magnetic tape, and a memory card such as a flash memory. In addition, examples of the recording media fixed to the computer include a hard disk and a read-only memory (ROM). Further, a solid state drive (SSD) can be used as the recording medium removable from the computer or as the recording medium fixed to the computer.

Information Processing System

As another embodiment, the functions of the user identification unit 111, the group information generation unit 112, and the consumption information generation unit 113 may be divided and executed by a plurality of devices communicable with each other via the network NW.

### Other Embodiments

Further, in the wallet server 10, the payment service provider server 20, the user terminal 30, and the store terminal 40 according to the embodiment, the “unit” can be read as a “circuit”, for example. For example, the communication unit can be read as a communication circuit.

Further, the program to be executed by the wallet server 10, the payment service provider server 20, the user terminal 30, and the store terminal 40 according to the embodiment may be configured to be stored in a computer connected to a network such as the Internet and executed by being downloaded via the network.

In the description of the flowchart in the present specification, the order of the processing between steps is clarified using expressions such as “first”, “after”, and “subsequently”. However, the order of processing required for realizing the embodiment is not always uniquely defined by those representations. That is, the order of processing in the flowchart described in the present specification can be changed within a consistent range.

Further effects and modifications can be easily derived by those skilled in the art. The broader aspects of the present disclosure are not limited to the particular details and representative embodiments shown and described above. Accordingly, various modifications may be made without departing from the spirit or scope of the general inventive concept as defined by the appended claims and their equivalents.

What is claimed is:

1. A wallet server, comprising a processor provided with hardware, wherein the processor
acquires user information of a plurality of user terminals output from a store terminal that is provided in a store and executes payment settlement processing,
generates, when a predetermined user terminal among the user terminals executes the payment settlement processing, group consumption information based on group information containing the user information of the predetermined user terminal and the user information of the other user terminals and consumption information associated with each of the user terminals contained in the group information, and
generates payment information including an allotted amount of the predetermined user terminal with respect to a target user terminal based on the group consumption information.

2. The wallet server according to claim 1, wherein
the processor
selects the other user terminals that constitute a group with the predetermined user terminal based on the user information of the user terminals and generates the group information containing the user information of the predetermined user terminal and the user information of the other user terminals, and
calculates an amount as the allotted amount such that a part of a payment settlement amount in the payment settlement processing is allocated in association with the other user terminals that constitute the group, and generates the consumption information associated with each of the user terminals that constitute the group.

3. The wallet server according to claim 2, wherein the processor selects the other user terminals that constitute the group based on location information acquired from the predetermined user terminal and the other user terminals, and generates the group information.

4. The wallet server according to claim 2, wherein the processor acquires the user information based on communication between the predetermined user terminal and the other user terminals, and a radio beacon communication unit by which information is exchangeable with the store terminal and that is communicable with the user terminals, selects the other user terminals that constitute the group, and generates the group information.

5. The wallet server according to claim 2, wherein the processor acquires the user information from the store terminal, the user information acquired by the store terminal by reading a barcode symbol displayed on the predetermined user terminal and the other user terminals, selects the other user terminals that constitute the group based on the acquired user information, and generates the group information.

6. The wallet server according to claim 2, wherein the processor acquires the user information based on information acquired by the predetermined user terminal and the other user terminals by reading a barcode symbol displayed on the store terminal, selects the other user terminals that constitute the group, and generates the group information.

7. The wallet server according to claim 1, wherein the processor adds, when the target user terminal transmits data relating to presentation of a product from the target user terminal to the predetermined user terminal based on payment information of the predetermined user terminal or the target user terminal, an amount corresponding to the product to the allotted amount in the payment information of the target user terminal.

8. The wallet server according to claim 1, wherein
the processor
acquires, from the store terminal, purchase information containing information on a payment settlement amount in the payment settlement processing and information on a product or a service provided to each of users who respectively hold the user terminals that constitute the group, and
generates the group consumption information using the purchase information.

9. The wallet server according to claim 1, wherein the payment information contains information on a user identification of the predetermined user terminal, user identifications of the other user terminals, and the allotted amount.

10. A wallet system, comprising:
a first device including a first processor that is provided with hardware installed in a store and executes payment settlement processing using a user terminal held by a user and outputs payment settlement information relating to payment settlement; and
a second device including a second processor that is provided with hardware, acquires user information of a plurality of the user terminals output from the first device, generates, when a predetermined user terminal among the user terminals executes the payment settlement processing, group consumption information based on group information containing the user information of the predetermined user terminal and the user information of the other user terminals and consumption information associated with each of the user terminals contained in the group information, and generates payment information containing an allotted amount of the predetermined user terminal with respect to a target user terminal based on the group consumption information.

11. The wallet system according to claim 10, wherein
the second processor
selects the other user terminals that constitute a group with the predetermined user terminal based on the user information of the user terminals and generates the group information containing the user information of the predetermined user terminal and the user information of the other user terminals, and
calculates an amount as the allotted amount such that a part of a payment settlement amount in the payment settlement processing is allocated in association with the other user terminals that constitute the group, and generates the consumption information associated with each of the user terminals that constitute the group.

12. The wallet system according to claim 11, wherein the second processor selects the other user terminals that constitute the group based on location information acquired from the predetermined user terminal and the other user terminals.

13. The wallet system according to claim 11, wherein the second processor acquires the user information based on communication between the predetermined user terminal and the other user terminals, and a radio beacon communication unit by which information is exchangeable with the first device and that is communicable with the user terminals, and selects the other user terminals that constitute the group.

14. The wallet system according to claim 11, wherein the second processor acquires the user information from the first device, the user information acquired by the first device by reading a barcode symbol displayed on the predetermined user terminal and the other user terminals, and selects the other user terminals that constitute the group based on the acquired user information.

15. The wallet system according to claim 11, wherein the second processor acquires the user information based on information acquired by the predetermined user terminal and the other user terminals by reading a barcode symbol displayed on the first device, and selects the other user terminals that constitute the group.

16. The wallet system according to claim 11, wherein the second processor adds, when the predetermined user terminal presents a product to the other user terminals, an amount corresponding to the product to the allotted amount in the payment information of the predetermined user terminal based on the payment information of the predetermined user terminal or the target user terminal.

17. The wallet system according to claim 10, wherein:
the first device outputs purchase information containing information on a payment settlement amount in the payment settlement processing and information on a product or a service provided to each of users who respectively hold the user terminals that constitute the group; and
the second processor acquires the purchase information and generates the group consumption information.

18. The wallet system according to claim 10, wherein the payment information contains information on a user identification of the predetermined user terminal, user identifications of the other user terminals, and the allotted amount.

19. A program that causes a processor provided with hardware to execute:
acquisition of user information of a plurality of user terminals output from a store terminal that is provided in a store and executes payment settlement processing;
generation of, when a predetermined user terminal among the user terminals executes the payment settlement processing, group consumption information based on group information containing the user information of the predetermined user terminal and the user information of the other user terminals and consumption information associated with each of the user terminals contained in the group information; and
generation of payment information including an allotted amount of the predetermined user terminal with respect to a target user terminal based on the group consumption information.

20. The program according to claim 19, wherein the payment information contains information on a user identification of the predetermined user terminal, user identifications of the other user terminals, and the allotted amount.
